(19) United States
(12) Patent Application Publication
(10) Pub. No.: US 2026/0205345 A1
(43) Pub. Date: Jul. 16, 2026

(54) SYSTEM FOR WIRELESS COMMUNICATION IN DATA LINKS

(71) Applicant: VIETTEL GROUP, Ha Noi City (VN)

(72) Inventors: THI HOAI LINH NGUYEN, Ha Noi City (VN); TRUONG XUAN DO, Ha Noi City (VN); VAN THO NGUYEN, Ha Noi City (VN); NGOC TUNG PHAM, Ha Noi City (VN); MINH TUAN VU, Ha Noi City (VN); HUU TUNG DANG, Ha Noi City (VN); HONG HUY THONG NGUYEN, Ha Noi City (VN)

(73) Assignee: VIETTEL GROUP, Ha Noi City (VN)

(21) Appl. No.: 19/433,757

(22) Filed: Dec. 27, 2025

(30) Foreign Application Priority Data
Dec. 27, 2024 (VN) 1-2024-09791

(51) Int. Cl. H04L 27/36; H04L 25/02

(52) U.S. Cl. CPC H04L 27/364; H04L 25/0202

(57) ABSTRACT

The invention proposes a radio communication system for data links. On the transmit side, the system uses single-carrier modulation in order to simplify the modulation design and reduce computational complexity on the transmit side so that it can be installed on airborne platforms. On the receive side, the system addresses crucial issues in high-speed data transmission and reception, including frame synchronization, frequency-offset estimation and compensation, and channel equalization in the frequency domain based on the MMSE method. As a result, the proposed system can adapt well to diverse environments and is suitable for communication systems in various fields, such as military communication systems.

### TECHNICAL FIELD

The invention presents a radio communication system for data links in line-of-sight (LOS-line of sight) conditions. In particular, the system disclosed in the invention is mainly applied in military communication systems, where stringent requirements on information security, anti-interference capability and stability in harsh environments are mandatory.

### BACKGROUND OF THE INVENTION

In the field of military communications, the need to share information and data over radio links has existed for a long time. Previously, data link communications mainly provided voice, messages and images at very low bit rates (several tens of bits per second). Typical military data link systems include Link 11 and Link 16 (Link 11 and Link 16 are terms used in NATO-based military systems and by other countries using such systems).

The Link 11 system operates in the high-frequency (HF) and ultra-high-frequency (UHF) bands for line-of-sight communication links and provides a maximum data rate of 2.25 kbps. Link 11 uses Hamming bits for error detection and correction and phase shift keying (PSK) modulation. The Link 16 system operates in the UHF band and provides a maximum data rate of 115 kbps. Link 16 uses minimum shift keying (MSK) modulation and Reed-Solomon (RS) codes for error correction. These systems have the disadvantages of low data rates, weak coding and security capability, complex design architecture and large physical size.

In recent years, along with the outstanding development of radio technology, the need to build data links in wireless communication environments has become a key factor. Ensuring high-speed transmission between a transmitter and a receiver requires the system to meet many technical challenges. In particular, modern applications often need to share large volumes of data such as high-resolution video or detailed images in real time.

To meet the requirements of high-speed, stable and reliable communication for data links in radio environments, the design solution needs to satisfy the following requirements:
(i) the design solution and transmission processing chain must ensure a simple transceiver architecture that can be easily integrated with various mobile platforms;
(ii) high-speed data transmission;
(iii) data must be encrypted so as to secure information on the transmission path, because data are transmitted over an open radio environment;
(iv) data must be able to be transmitted in environments with noise, multipath (fading), and large transmit/receive frequency offsets caused by the Doppler effect due to relative motion between the receiver and the transmitter.

To satisfy the above requirements, the invention proposes a system and method that enables high-speed transmission for data links.

### Technical Nature of the Invention

The objective of the invention is to provide a high-speed radio communication system with a radio transceiver architecture. In this architecture, the transmit-receive processing chain uses single-carrier modulation combined with frequency-domain equalization (SC-FDE—single-carrier frequency-domain equalization), thereby satisfying the requirement of a simple transceiver architecture suitable for integration into various devices while ensuring high-speed transmission for line-of-sight data links.

The system comprises thirteen blocks as follows:

On the transmit (Tx) side of the high-speed transmission system for data links, designed on the basis of single-carrier modulation, the following blocks are included:
Bit-encoding block (101):
The bit-encoding block uses Turbo codes with a code rate of ⅓ in combination with puncturing and interleaving techniques.
M-PSK/M-QAM modulation block (102):
The data after the bit-encoding block are scrambled before M-PSK/M-QAM modulation (M-ary phase shift keying (M-PSK)/M-ary quadrature amplitude modulation (M-QAM)).
Cyclic-prefix (CP) insertion block (103):
This block inserts a cyclic prefix.
Data-multiplexing block (104):
This block combines a synchronization signal, a frame-end signal, pilot signals and the data after CP insertion to form transmission frames.
Interpolation and transmit-filtering block (105):
This block upsamples (interpolates) the signal by a factor of two relative to the input signal so that the sampling rate of the signal before transmission is doubled with respect to the input signal. Finally, the signal is passed through a transmit filter before the IQ signal is transmitted into the radio environment.

On the receive (Rx) side, the following blocks are included:
Receive-filter block (107):
This block filters the received signal to reduce the influence of noise from the environment on the signal.
Frame-synchronization block (108):
This block performs frame synchronization using a threshold based on the variation of the power of the input signal, helping to maintain optimal sensitivity. After successful frame synchronization, the signal is resampled (down-sample) so that the sampling rate is reduced by one half with respect to the input sampling rate.
Frequency-offset estimation block (109):
This block estimates and compensates the frequency offset based on the cyclic prefix of OFDM (orthogonal frequency division multiplexing) symbols and accumulates over multiple OFDM symbols and multiple frames to reduce noise and increase accuracy. After estimating the frequency offset, the system obtains a phase array, then calculates the complex exponential of this phase array to obtain cosine and sine values. A pointwise multiplication between the input and the complex conjugate of the cosine and sine array produces an output signal in which the frequency offset has been compensated.
CP-removal block (110):
This block removes the cyclic prefix inserted on the transmit side.
Channel-estimation and equalization block (111):
This block performs channel estimation and equalization. A frequency-domain equalization (FDE) channel-estimation and equalization algorithm based on the minimum mean-square error (MMSE) criterion is used to mitigate the effects of multipath channels and to significantly reduce computational complexity in hardware, making it suitable for high-speed transmission systems, particularly when the system faces complex and disturbed propagation environments.
M-PSK/M-QAM demodulation block (112):
This block performs M-PSK/M-QAM demodulation (M-ary phase shift keying (M-PSK) or M-ary quadrature amplitude modulation (M-QAM)) in combination with descrambling.
Bit-decoding block (113):
This block performs turbo error-correction decoding (Turbocodes) in combination with deinterleaving and depuncturing before reconstructing the original signal, so that the signal is recovered with high accuracy and minimized errors.

In this invention, the SC-FDE (single-carrier frequency-domain equalization) technique is applied, using single-carrier modulation instead of multicarrier modulation such as OFDM, in order to simplify the modulation design and reduce computational complexity on the transmit side. On the receive side, the processing chain of the system addresses important issues encountered in high-speed data transmission and reception, including: frame synchronization; frequency-offset estimation and compensation, which is suitable for scenarios where platforms move at high speed; channel estimation and equalization in the frequency domain based on the MMSE (minimum mean-square error) method; and turbo decoding (Turbocodes) to improve decoding performance.

As a result, the proposed system can adapt well to diverse environments and is suitable for communication systems in various fields, such as military communication systems.

### BRIEF DESCRIPTION OF THE DRAWINGS

FIG. 1 is a block diagram of the high-speed wireless transceiver system for data links.

FIG. 2 is a diagram illustrating the waveform structure of the system.

FIG. 3 is a diagram illustrating in detail the processing flow of the frame-synchronization algorithm.

FIG. 4 is a diagram illustrating in detail the processing flow of the frequency-offset estimation algorithm.

FIG. 5 is a diagram illustrating in detail the processing flow of the channel-estimation and equalization algorithm.

### DETAILED DESCRIPTION OF THE INVENTION

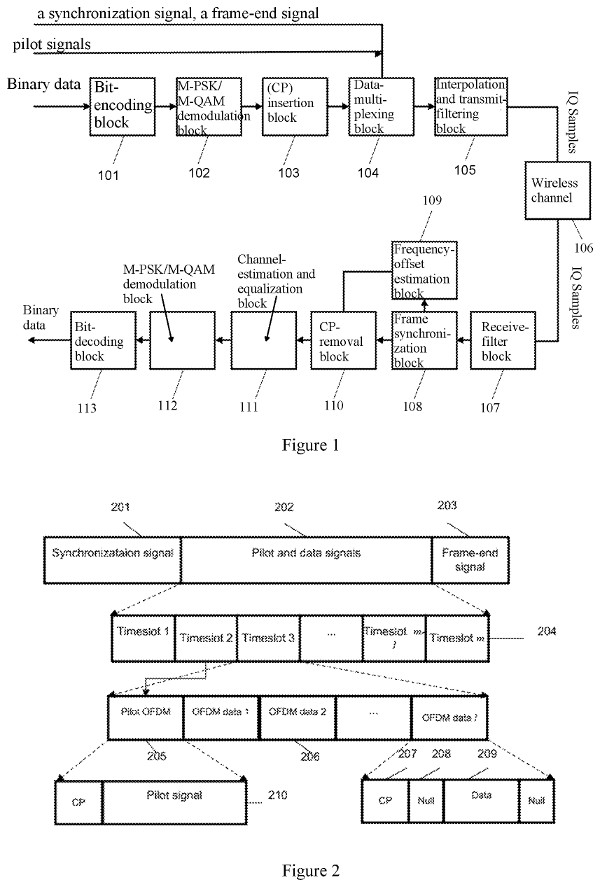

FIG. 1 illustrates the functional blocks of the high-speed wireless transceiver system for data links, including the functional blocks on the transmit side and the functional blocks on the receive side, specifically as follows.

### Transmit Side (Tx)

The transmit (Tx) side comprises the following blocks:

### Bit-Encoding Block 101:

The input of this block is the data to be transmitted, in binary (bit) form. The output is error-correcting encoded data. This block performs turbo coding (Turbocodes) with a code rate of ⅓. This means that each input bit is encoded into three output bits. To achieve desired code rates such as ½, ⅔ or ¾, the system uses a puncturing technique. The function of the puncturing technique is to reduce the number of bits that need to be transmitted while still maintaining the error-correction capability of the code.

In addition, an interleaving technique is performed after puncturing. The purpose of using interleaving is to improve decoder performance and reduce burst errors caused by the transmission channel. The input size of the interleaving block equals the length of the bit stream after puncturing.

### M-PSK/M-QAM Modulation Block 102:

The binary data after bit encoding are converted into decimal symbols depending on the type of modulation. To reduce autocorrelation and repeating patterns in the transmitted signal, the decimal data are scrambled according to a scrambling table, and then mapped onto the M-PSK/M-QAM constellations (M-ary phase shift keying (M-PSK) or M-ary quadrature amplitude modulation (M-QAM)). The output of this block is IQ data after modulation.

### CP-Insertion Block 103:

The input IQ data are divided into segments of samples N_{FFT}−Nₙ, where N_{FFT} is the size of the fast Fourier transform (FFT—Fast Fourier Transform) and Nₙ is the number of Null samples inserted for the purpose of protecting the data at the two ends of each OFDM symbol. The CP (cyclic prefix) part consists of samples. The output of this block is the signal samples after CP insertion. Referring to FIG. 2, each OFDM signal symbol 206 includes CP samples 207, data samples after M-PSK/M-QAM modulation 209, and Null samples 208 that protect the two ends of the data of each OFDM symbol.

### Data-Multiplexing Block 104:

This block multiplexes multiple signal samples and pilot samples that are formed from data OFDM samples 206 and pilot OFDM samples 205 with the synchronization part 201 and the frame-end part 203 to form a complete waveform frame as illustrated in FIG. 2. In this frame, the pilot signal and data 202 are divided into m time slots 204. Each time slot comprises one pilot OFDM symbol 205 and l data OFDM symbols 206. Each pilot OFDM symbol 205 includes N_{g} CP samples and N_{FFT} pilot samples 210.

### Interpolation and Transmit-Filtering Block 105:

This block upsamples (interpolates) the signal after block 104 by a factor of two, which means that the sampling rate of the signal is doubled with respect to the input sampling rate. After the signal is upsampled by a factor of two, it is passed through a transmit filter, then modulated onto the carrier and transmitted into the radio environment.

### Radio-Frequency Block 106:

This is the radio-frequency channel between the transmitter and the receiver.

### Receive Side (Rx)

The receive (Rx) side comprises the following blocks:

### Receive-Filter Block 107:

This block filters the received signal.

### Frame-Synchronization Block 108:

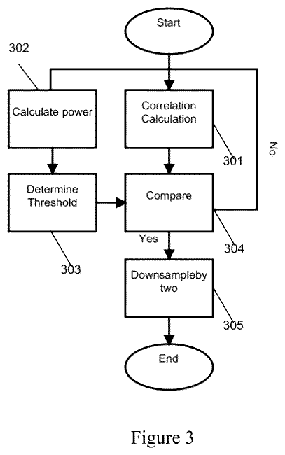

This block finds the start point of each transmitted frame based on the synchronization signal by adjusting a threshold according to the power of the received signal. The frame-synchronization and down-sampling (by a factor of two) algorithm shown in FIG. 3 includes the following steps:
Step 301: calculate the correlation R between the received signal sequence after filtering and a reference signal which is the synchronization signal inserted on the transmit side.
Step 302: calculate the power P of the input signal.
Step 303: determine a threshold value based on the power value (denoted Threshold_{P}). The purpose of step 303 is to reduce the computational complexity in hardware by adapting the threshold to the power of the received signal. Instead of using a fixed threshold, the algorithm automatically adjusts the threshold based on the variation of the power of the input signal, helping to keep the sensitivity at an optimal level. Specifically, when the signal power is high, the threshold can be increased to reduce noise and avoid false detections, whereas when the signal power is low, the threshold is lowered to maintain detection capability.
Step 304: compare the maximum value obtained from the correlation in step 301 (denoted maxValue_{R}) with the adaptive threshold obtained from step 302 in order to determine the synchronization flag.

If the maxValue_{R}≥Threshold_{P}, the synchronization flag indicates successful synchronization, and the synchronization flag is set to 1 (Yes).

Otherwise, the synchronization flag indicates unsuccessful synchronization and is set to 0 (No). The algorithm then returns to step 301 to continue calculating the correlation R.
Step 305: after successful synchronization, once the start point of the frame has been determined, the received signal is downsampled by a factor of two so that the sampling rate is reduced by one half compared with the original sampling rate.

### Frequency-Offset Estimation Block 109:

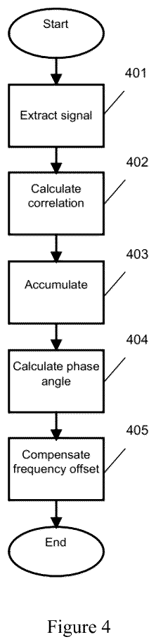

This block estimates the frequency offset based on an accumulation algorithm applied to the cyclic-prefix data. Specifically, the frequency-offset estimation and compensation algorithm shown in FIG. 4 comprises the following steps:
Step 401: extract the cyclic-prefix values of each OFDM symbol.
Step 402: calculate the correlation between cyclic-prefix sequences.
Step 403: accumulate the correlation values calculated in step 402 over multiple OFDM symbols and multiple frames to reduce noise and increase accuracy.
Step 404: calculate the phase angle based on the accumulated value stored in step 403. On the basis of the phase angle, calculate the frequency offset of the system.
Step 405: from the frequency offset, calculate a phase array, then calculate the complex exponential of this phase array to obtain cosine and sine values. A pointwise multiplication between the input signal and the complex conjugate of the cosine and sine array yields an output signal in which the frequency offset has been compensated.

### CP-Removal Block 110:

The signal after frequency-offset compensation in block 109 is passed to this block, which removes the cyclic prefix (CP) before channel estimation and equalization.

### Channel-Estimation and Equalization Block 111:

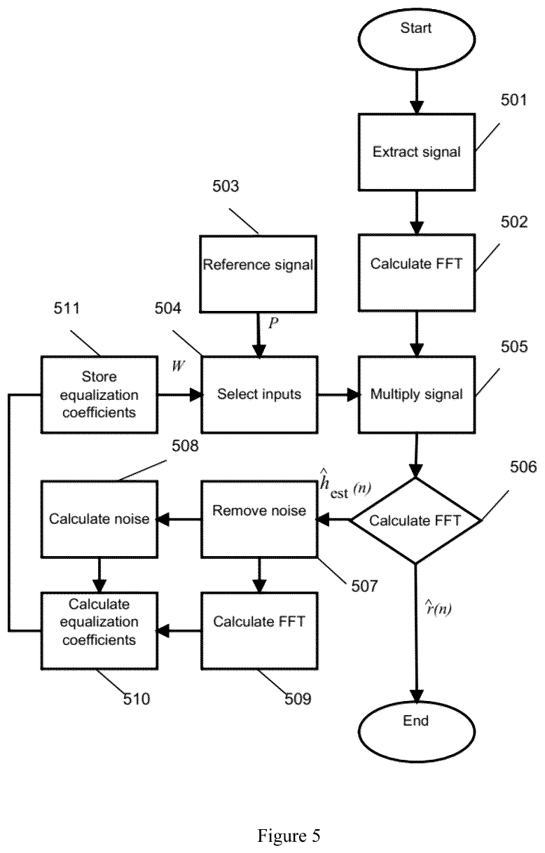

This block estimates the channel characteristics based on pilot reference values in the frequency domain using the MMSE estimation method. The detailed processing flow of the channel-estimation and equalization algorithm shown in FIG. 5 comprises the following steps:
Step 501: extract the received data after frequency-offset compensation. The extracted data may be pilot signals or data signals.
Step 502: transform the extracted signal into the frequency domain using a fast Fourier transform (FFT)R(k)=FFT[r(n)]. After that, normalize the amplitude of the FFT output by reducing the amplitude by a factor of \sqrt{N_{FFT}} to compensate for the FFT gain.

$$R ( k ) = R ( k ) * \frac{1}{\sqrt{{N}_{F F T}}}$$

Step 503: calculate the inverse (reciprocal) of the pilot reference values in the frequency domain.
Step 504: depend on the type of extracted data (pilot signal or data signal), this step selects the input data of multiplier block in step 505. If the extracted data is pilot, the output of selector is the reciprocal of the pilot reference values P. If the extracted data is data signal, the output of selector is channel-equalization coefficients W.
Step 505: perform a multiplication operation. Depending on the output of the selector in step 504, the input to the multiplier block is either the reciprocal of the pilot reference values in the frequency domain P, or the channel-equalization coefficients W.
   If the input data are the values P, the output is the channel frequency response, denoted Hₑₛₜ(k).
   If the input data are the coefficients W, the output is the data after channel equalization in the frequency domain.
Step 506: transform the output signal of step 503 (either the channel frequency response or the equalized data) from the frequency domain to the time domain by an inverse FFT (IFFT).
If the input signal is the value Hₑₛₜ(k), the IFFT yields the channel impulse response in the time domain hₑₛₜ(n)

$${h}_{e s t} ( n ) = IFFT \{ {H}_{e s t} ( k ) \}$$

If the input signal is the equalized data in the frequency domain, the IFFT yields the data in the time domain. The output data of the IFFT block are then passed to the M-PSK/M-QAM demodulation block.

Afterwards, normalize the amplitude by amplifying the amplitude of the signal after IFFT by a factor of \sqrt{N_{FFT}} to compensate for the IFFT operation.
Step 507: remove data outside the cyclic-prefix interval of the channel impulse response hₑₛₜ(n) by setting them to zero so as to reduce the influence of noise on the accuracy of the channel-estimation result using following formula:

$${\hat{h}}_{e s t} ( n ) = \{ \begin{matrix}{h}_{est} ( n ) , 0 \leq n < {N}_{g} \\ 0 , {N}_{g} \leq n < {N}_{FFT}\end{matrix}$$

In which,
   hₑₛₜ(n): denotes the channel impulse response in the time domain calculated in step 504.
Step 508: calculate the noise σ² using the following equation:

$${σ}^{2} = \frac{1}{2 ( {N}_{F F T} - {N}_{g} )} {\sum }_{n = {N}_{g}}^{{N}_{F F T} - 1} \vert {h}_{e s t} ( n ) {\vert}^{2}$$

Step 509: transform the signal into the frequency domain using an FFT. Afterwards, normalize the amplitude by reducing the amplitude of the FFT output by a factor of \sqrt{N_{FFT}}
Step 510: calculate the channel-equalization coefficients. The equalization nnm coefficients are calculated according to equation:

$$W ( k ) = \frac{{( {H}_{est}^{′} )}^{*} ( k )}{\vert {H}_{e s t}^{′} ( k ) {\vert}^{2} + 2 {σ}^{2}}$$

In which,
   W (k) denotes the MMSE channel-equalization coefficients;
   (⋅)*và σ² are respectively complex conjugation and the variance of the estimation noise, which are parameters to be estimated.
Step 511: store the channel-equalization coefficients W.

### M-PSK/M-QAM Demodulation Block 112:

The signal processed by the channel-estimation and equalization block 111 is first descrambled and then demodulated by the M-PSK/M-QAM demodulator. The demodulation process in M-PSK (M-ary phase shift keying) and M-QAM (M-ary quadrature amplitude modulation) reconstructs the original data from the signal received after propagation through the channel. The output of the M-PSK/M-QAM demodulation block is soft-decision data (soft bits).

### Bit-Decoding Block 113:

This block performs deinterleaving to rearrange the data back into the original order before depuncturing. Finally, turbo decoding (Turbocodes) is carried out on the binary data to produce the decoded output data.

1. A system for wireless communication in data links, comprising:
a transmit (Tx) side including the following blocks:
a bit-encoding block, whose input is data to be transmitted in binary (bit) form and whose output is error-correcting encoded data, the bit-encoding block performing turbo coding (Turbocodes) with a code rate (coderate) of ⅓, such that each input bit is encoded into three output bits; in order to achieve desired code rates such as ½, ⅔ or ¾, the system uses a puncturing technique, to reduce the number of bits to be transmitted while still maintaining the error-correction capability of the code; furthermore, an interleaving technique is performed after puncturing, to improve decoder performance and reduce burst errors caused by the transmission channel; an input size of an interleaving block equals a length of a bit stream after puncturing;
an M-PSK/M-QAM modulation block, in which binary data after bit encoding are converted into decimal symbols depending on a type of modulation; to reduce autocorrelation and repeating patterns in a transmitted signal, decimal data are scrambled according to a scrambling table and then mapped onto M-PSK/M-QAM constellations (M-ary phase shift keying (M-PSK) or M-ary quadrature amplitude modulation (M-QAM)); output of this block is IQ data after modulation;
a cyclic-prefix (CP) insertion block, in which input IQ data are divided into N_{FFT}−Nₙ segments of samples, where N_{FFT} is the size of a fast Fourier transform and Nₙ is a number of Null samples inserted for a purpose of protecting data at the two ends of each OFDM symbol; a CP (cyclic prefix) part consists of N_{g} samples; an output of this block is signal samples after CP insertion; each OFDM signal symbol includes N_{g} CP samples, (N_{FFT}−Nₙ) data samples after M-PSK/M-QAM modulation, and Null samples that protect two ends of the data of each OFDM symbol;
a data-multiplexing block, which multiplexes multiple signal samples and pilot samples that are formed from data OFDM samples and pilot OFDM samples with a synchronization part and a frame-end part to form a complete waveform frame; in this frame, a pilot signal and data are divided into time slots; each time slot comprises one pilot OFDM symbol and data OFDM symbols; each pilot OFDM symbol includes N_{g} CP samples and N_{FFT} pilot samples;
an interpolation and transmit-filtering block, which upsamples (interpolates) the signal after the data-multiplexing block by a factor of two, such that a sampling rate of the signal is doubled relative to an input sampling rate; after the signal is upsampled by a factor of two it is passed through a transmit filter, then modulated onto a carrier and transmitted into the radio environment;
a radio-frequency block, which is a radio-frequency channel between a transmitter and the receiver;
and a receive (Rx) side including the following blocks:
a receive-filter block, which filters a received signal;
a frame-synchronization block, which finds a start point of each transmitted frame based on a synchronization signal by adjusting a threshold according to the power of the received signal, and performs the following steps:
step 301: calculating the correlation R between the received signal sequence after filtering and a reference signal which is the synchronization signal inserted on the transmit side;
step 302: calculating the power P of the input signal;
step 303: determining a threshold value based on a power value (denoted threshold_{P}), the purpose of step 303 being to reduce computational complexity in hardware by adapting a threshold to the power of the received signal; specifically, when the signal power is high the threshold can be increased to reduce noise and avoid false detections, whereas when the signal power is low the threshold is lowered to maintain detection capability;
step 304: comparing a maximum value obtained from the correlation in step 301 (denoted maxValue_{R}) with an adaptive threshold threshold_{P} obtained from step 302 in order to determine a synchronization flag:
if maxValue_{R}≥Threshold_{P}, the synchronization flag indicates successful synchronization and is set to 1 (Yes);
otherwise, the synchronization flag indicates unsuccessful synchronization and is set to 0 (No), and the algorithm then returns to step 301 to continue calculating the correlation R;
step 305: after successful synchronization, once a start point of the frame has been determined, downsampling the received signal by a factor of two so that the sampling rate is reduced by one half compared with an original sampling rate;
a frequency-offset estimation block 109, which estimates a frequency offset based on an accumulation algorithm applied to the cyclic-prefix data and performs the following steps:
step 401: extracting the cyclic-prefix values of each OFDM symbol;
step 402: calculating a correlation between cyclic-prefix sequences;
step 403: accumulating the correlation values calculated in step 402 over multiple OFDM symbols and multiple frames to reduce noise and increase accuracy;
step 404: calculating a phase angle based on the accumulated value stored in step 403 and, based on the phase angle, calculating a frequency offset of the system;
step 405: from the frequency offset, calculating a phase array, then calculating a complex exponential of this phase array to obtain cosine and sine values, and performing a pointwise multiplication between the input signal and a complex conjugate of the cosine and sine array so as to obtain an output signal in which the frequency offset has been compensated;
a CP-removal block, which, after frequency-offset compensation, removes the cyclic prefix (CP) before channel estimation and equalization;
a channel-estimation and equalization block, which estimates channel characteristics based on pilot reference values in the frequency domain using the MMSE estimation method, and performs the following steps:
step 501: extracting received data after frequency-offset compensation, extracted data being pilot signals or data signals;
step 502: transforming the extracted signal into the frequency domain using a fast Fourier transform R(k)=FFT[r(n)], and then normalizing an amplitude of the FFT output by reducing the amplitude by a factor of \sqrt{N_{FFT}} to compensate for the FFT gain;
$$R ( k ) = R ( k ) * \frac{1}{\sqrt{{N}_{F F T}}}$$
step 503: calculating an inverse (reciprocal) of the pilot reference values in the frequency domain;
step 504: depend on the type of extracted data (pilot signal or data signal), selecting the input data of multiplier block in step 505, if the extracted data is pilot, output of selector is a reciprocal of the pilot reference values P, if the extracted data is data signal, output of selector is channel-equalization coefficients W;
step 505: performing a multiplication operation, in which, depending on the output of the selector in step 504, input to the multiplier block is either the reciprocal of the pilot reference values in the frequency domain P or channel-equalization coefficients W;
if the input data are the values P, the output is the channel frequency response, denoted Hₑₛₜ(k);
if the input data are the coefficients W, the output is the data after channel equalization in the frequency domain;
step 506: transforming the output signal of step 503 from the frequency domain to the time domain by an inverse FFT;
if the input signal is the value Hₑₛₜ(k), the IFFT yields a channel impulse response in the time domain according to following equation;
$${h}_{e s t} ( n ) = IFFT \{ {H}_{e s t} ( k ) \}$$
if the input signal is the equalized data in the frequency domain, the IFFT yields the data in the time domain, which are then passed to the M-PSK/M-QAM demodulation block; afterwards, normalizing the amplitude by amplifying the amplitude of the signal after IFFT by a factor of \sqrt{N_{FFT}};
step 507: removing data outside the cyclic-prefix interval of the channel impulse response by setting them to zero so as to reduce an influence of noise on accuracy of the channel-estimation result according to following formula;
$${\hat{h}}_{e s t} ( n ) = \{ \begin{matrix}{h}_{est} ( n ) , 0 \leq n < {N}_{g} \\ 0 , {N}_{g} \leq n < {N}_{FFT}\end{matrix}$$
In which,
hₑₛₜ(n): in which denotes the channel impulse response in the time domain calculated in step 504;
step 508: calculating a noise σ² according to a predetermined formula:
$${σ}^{2} = \frac{1}{2 ( {N}_{F F T} - {N}_{g} )} {\sum }_{n = {N}_{g}}^{{N}_{F F T} - 1} \vert {h}_{e s t} ( n ) {\vert}^{2}$$
step 509: transforming the signal into the frequency domain using an FFT and thereafter normalizing the amplitude by reducing an amplitude of the FFT output by a factor of \sqrt{N_{FFT}};
step 510: calculating the channel-equalization coefficients, the equalization coefficients being calculated according to a predetermined formula:
$$W ( k ) = \frac{{( {H}_{est}^{′} )}^{*} ( k )}{\vert {H}_{e s t}^{′} ( k ) {\vert}^{2} + 2 {σ}^{2}}$$
In which,
W(k) denotes the MMSE (minimum mean square error) channel-equalization coefficients;
(⋅)* and σ² denote respectively complex conjugation and a variance of the estimation noise
step 511: storing the channel-equalization coefficients W;
an M-PSK/M-QAM demodulation block, in which the signal processed by the channel-estimation and equalization block is first descrambled and then demodulated by the M-PSK/M-QAM demodulator, the demodulation process in M-PSK and M-QAM reconstructing the original data from a signal received after propagation through the channel, output of the M-PSK/M-QAM demodulation block being soft-decision data (soft bits);
and a bit-decoding block, which performs deinterleaving to rearrange the data back into an original order before depuncturing, and finally performs turbo decoding (Turbocodes) on the binary data to produce the decoded output data.
